(19) United States
(12) Patent Application Publication
(10) Pub. No.: US 2017/0183461 A1
(43) Pub. Date: Jun. 29, 2017

(54) MICROCAPILLARY FILMS

(71) Applicant: Dow Global Technologies LLC, Midland, MI (US)

(72) Inventors: Julie W. McKenna, McKinney, TX (US); Debkumar Bhattacharjee, Blue Bell, PA (US); Joseph Dooley, Midland, MI (US); Wenyi Huang, Midland, MI (US); Todd O. Pangburn, Midland, MI (US); Rajen M. Patel, Lake Jackson, TX (US)

(21) Appl. No.: 15/118,177

(22) PCT Filed: Jan. 30, 2015
(86) PCT No.: PCT/US2015/013656

§ 371 Date: Aug. 11, 2016

Related U.S. Application Data
(60) Provisional application No. 61/939,313, filed on Feb. 13, 2014.

(51) Int. Cl. C08J 5/18; B32B 27/32; B32B 3/20

(52) U.S. Cl. CPC C08J 5/18; B32B 3/20; B32B 27/32; C08J 2323/06; C08J 2423/20

(57) ABSTRACT

The instant invention provides microcapillary films. The inventive microcapillary film according to the present invention comprises a first end and a second end, wherein the microcapillary film comprises: (a) a matrix comprising a thermoplastic material, (b) at least one or more channels disposed in parallel in said matrix from the first end to the second end of said film, wherein said one or more channels are at least 1 μm apart from each other, and wherein each said one or more channels have a diameter in the range of at least 1 μm; and wherein said microcapillary film comprise from 10 to 90 percent by volume of voidage, based on the total volume of the microcapillary film, and wherein said one or more channels has a aspect ratio in the range of from 1:1 to 100:1; and wherein said film has a thickness in the range of from 5 μm to 500 μm.

### FIELD OF INVENTION

The instant invention relates to microcapillary films, and articles made therefrom.

### BACKGROUND OF THE INVENTION

The use of polymeric materials in various film and packaging applications is generally known; however, such various film and packaging applications require further improvements.

Despite the research efforts in providing improved use of polymeric materials in the film and packaging applications, there is a still a need for microcapillary films providing light-weighting of a film while maintaining optical and/or mechanical properties.

### SUMMARY OF THE INVENTION

The instant invention provides microcapillary films. The inventive microcapillary film according to the present invention comprises a first end and a second end, wherein the microcapillary film comprises: (a) a matrix comprising a thermoplastic material, (b) at least one or more channels disposed in parallel in said matrix from the first end to the second end of the film, wherein the one or more channels are at least 1 μm apart from each other, and wherein each said one or more channels have a diameter in the range of at least 1 μm; and wherein the microcapillary film comprises from 10 to 90 percent by volume of voidage, based on the total volume of the microcapillary film, and wherein said one or more channels have an aspect ratio in the range of from 1:1 to 100:1, measured as the ratio of the longest to shortest dimensions of a channel's cross-section perpendicular to the machine direction of the film; and wherein said film has a thickness in the range of from 5 μm to 500 μm, measured according to ASTM D374M-13.

In an alternative embodiment, the instant invention provides microcapillary films, in accordance with any of the preceding embodiments, except that the microcapillary film has a thickness in the range of from 5 μm to 500 μm, and wherein said microcapillary comprises a thermoplastic composition having a melt strength in the range of from 3 to 50 cN.

In an alternative embodiment, the instant invention provides microcapillary films, in accordance with any of the preceding embodiments, except that the microcapillary film has bending stiffness in the range of from 10 to 400% relative to a film of the same composition and same thickness absent any microcapillary channels, measured according to ASTM D6125-97 and/or TAPPI T543 om-11.

In an alternative embodiment, the instant invention provides microcapillary films, in accordance with any of the preceding embodiments, except that the microcapillary film has CD Tear Strength in the range of from 75 to 125% relative to a film of the same composition and same thickness absent any microcapillary channels, measured according to ASTM D1922.

In an alternative embodiment, the instant invention provides microcapillary films, in accordance with any of the preceding embodiments, except that the microcapillary film has CD Tear Strength (measured according to ASTM D1922)/MD Tear Strength (measured according to ASTM D1922) ratio in the range of from 1 to 40.

In an alternative embodiment, the instant invention provides microcapillary films, in accordance with any of the preceding embodiments except that the microcapillary film has Impact Strength in the range from 30 to 400% relative to a film of the same composition and same thickness absent any microcapillary channels, measured according to ASTM D3420.

In an alternative embodiment, the instant invention provides microcapillary films, in accordance with any of the preceding embodiments, except that the thermoplastic material is selected from the group consisting of polyolefin; polyamide; polyvinylidene chloride; polyvinylidene fluoride; polyurethane; polycarbonate; polystyrene; polyethylene vinylalcohol (PVOH), polyvinyl chloride, polylactic acid (PLA) and polyethylene terephthalate.

In an alternative embodiment, the instant invention provides microcapillary films, in accordance with any of the preceding embodiments, except that the polyolefin is polyethylene, polypropylene, propylene/ethylene copolymer, or copolymer of ethylene or propylene with one or more alpha-olefins.

In an alternative embodiment, the instant invention provides microcapillary films, in accordance with any of the preceding embodiments, except that the polyamide is nylon 6.

In an alternative embodiment, the instant invention provides microcapillary films, in accordance with any of the preceding embodiments, except that the one or more channels have a cross-sectional shape selected from the group consisting of circular, rectangular, oval, star, diamond, triangular, square, curvilinear, and combinations thereof.

In an alternative embodiment, the instant invention provides a multilayer structure comprising any one of the microcapillary films, in accordance with any of the preceding embodiments.

In an alternative embodiment, the instant invention provides an article any one of the microcapillary films, in accordance with any of the preceding embodiments.

### BRIEF DESCRIPTION OF THE DRAWINGS

For the purpose of illustrating the invention, there is shown in the drawings a form that is exemplary; it being understood, however, that this invention is not limited to the precise arrangements and instrumentalities shown.

FIG. 1 is a top view of an inventive microcapillary film;

FIG. 2 is a longitudinal-sectional view of an inventive microcapillary film;

FIG. 3 is a cross-sectional view of an inventive microcapillary film;

FIG. 4 is an elevated view of an inventive microcapillary film;

FIG. 5 is a segment of a longitudinal sectional view of the inventive microcapillary film, as shown in FIG. 2;

FIG. 6 is an exploded view of an inventive microcapillary film; and

FIGS. 7a-b are schematic illustration of a microcapillary die.

### DETAILED DESCRIPTION OF THE INVENTION

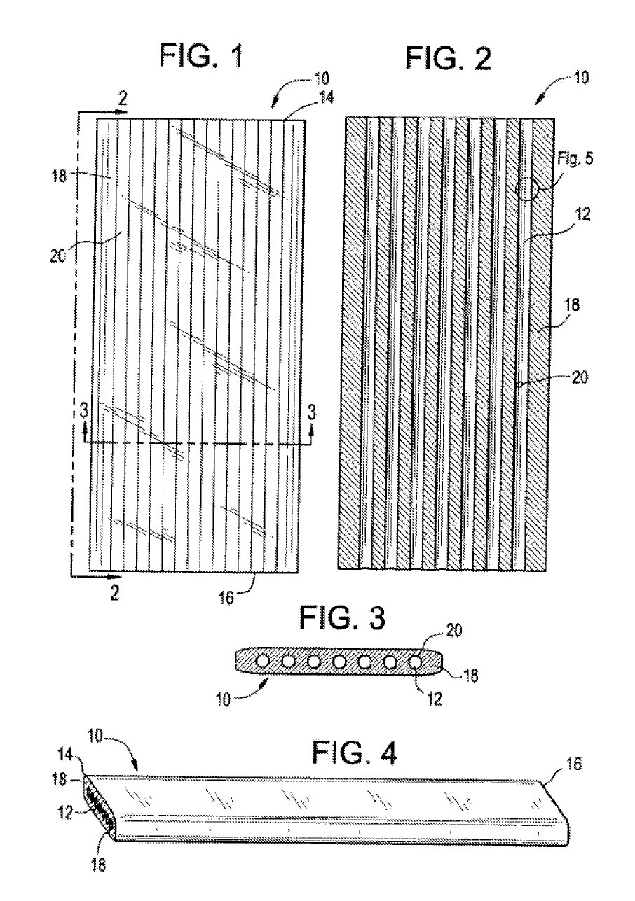

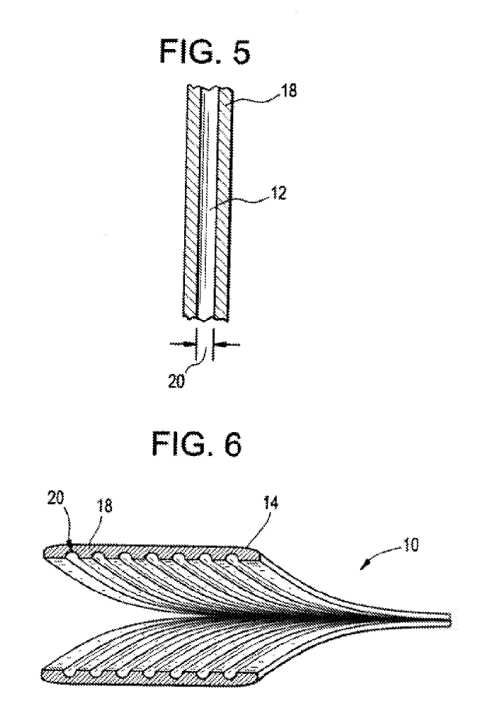

Referring to the drawings wherein like numerals indicate like elements, there is shown, in FIGS. 1-7, a first embodiment of a microcapillary film (10) containing void volumes (12).

The inventive microcapillary film (10) containing void volumes (12) according to the present invention has a first end (14) and a second end (16), and comprises: (a) a matrix (18) comprising a thermoplastic material; (b) at least one or more channels (20) disposed in parallel in said matrix (18) from the first end (14) to the second end (16) of said microcapillary film (10), wherein said one or more channels (20) are at least 1 μm apart from each other, and wherein each said one or more channels (20) have a diameter in the range of at least 1 μm; and wherein said microcapillary film (10) comprise from 10 to 90 percent by volume of voidage (12), based on the total volume of the microcapillary film (10), and wherein said one or more channels (20) has/have an aspect ratio in the range of from 1:1 to 100:1; and wherein microcapillary film (10) has a thickness in the range of from 5 μm to 500 μm.

The term “parallel” as used herein means extending in the same direction and never intersecting. The term diameter as used herein means longest axis of the channel (20) cross sectional.

The microcapillary film (10) containing void volumes (12) may have a thickness in the range of from 5 μm to 500 μm; for example, microcapillary film (10) containing void volumes (12) may have a thickness in the range of from 10 μm to 500 μm; or in the alternative, from 10 to 400 μm; or in the alternative, from 10 to 300 μm; or in the alternative, from 10 to 200 μm.

The one or more channels (20) can have an aspect ratio in the range of from 1:1 to 100:1; for example, in the range of from 10:1 to 100:1; or in the alternative, in the range of from 1:1 to 50:1; or in the alternative, in the range of from 10:1 to 50:1, measured as the ratio of longest to shortest dimensions of a channel's cross-section perpendicular to the machine direction (MD) of the film.

The one or more channels (20) can be at least partially filled with a gas, for example, air or an inert gas.

The microcapillary film (10) may comprise at least 10 percent by volume of the matrix (18), based on the total volume of the microcapillary film (10); for example, the microcapillary film (10) may comprise from 90 to 10 percent by volume of the matrix (18), based on the total volume of the microcapillary film (10); or in the alternative, from 80 to 20 percent by volume of the matrix (18), based on the total volume of the microcapillary film (10); or in the alternative, from 80 to 30 percent by volume of the matrix (18), based on the total volume of the microcapillary film (10); or in the alternative, from 80 to 50 percent by volume of the matrix (18), based on the total volume of the microcapillary film (10).

The microcapillary film (10) may comprise from 10 to 90 percent by volume of voidage, based on the total volume of the microcapillary film (10); for example, the microcapillary film (10) may comprise from 20 to 80 percent by volume of voidage, based on the total volume of the microcapillary film (10); or in the alternative, from 20 to 70 percent by volume of voidage, based on the total volume of the microcapillary film (10); or in the alternative, from 20 to 50 percent by volume of voidage, based on the total volume of the microcapillary film (10).

The inventive microcapillary film (10) has a first end (14) and a second end (16). At least one or more channels (20) are disposed in parallel in the matrix (18) from the first end (14) to the second end (16). The one or more channels (20) are at least 1 μm apart from each other. The one or more channels (20) have a diameter, i.e. the long axis, in the range of at least 1 μm; for example, from 1 μm to 2000 μm; or in the alternative, from 5 to 1200 μm; or in the alternative, from 500 to 1200 μm; or in the alternative, from 700 to 1200 μm. The one or more channels (20) may have a cross-sectional shape selected from the group consisting of circular, rectangular, oval, star, diamond, triangular, square, curvilinear, and combinations thereof. The one or more channels (20) may further include one or more seals at the first end (14), the second end (16), therebetween the first point (14) and the second end (16), and/or combinations thereof.

The inventive microcapillary film (10) may further be surface treated via, for example, corona surface treatment, plasma surface treatment, flame surface treatment, and/or chemical grafting surface treatment.

The matrix (18) comprises one or more thermoplastic materials. Such thermoplastic materials include, but are not limited to, polyolefin, e.g. polyethylene and polypropylene; polyamide, e.g. nylon 6; polyvinylidene chloride; polyvinylidene fluoride; polycarbonate; polystyrene; polyethylene terephthalate; polyester, and polyurethanes.

The selection of the thermoplastic material should provide sufficient melt strength such that during fabrication of such microcapillary films the microcapillaries maintain structural integrity to prevent the collapse of the microcapillaries. Such selection should also provide sufficient draw down capabilities thus enabling the formation of thin films. The selection of the material may also depend on other film and/or equipment design factors such as die gap, ultimate thickness of the film, and voidage volume and capillary geometry. The polymer should have melt strength of 3 to 50 cN, preferably 3 to 15 cN, as measured by the following procedure. The measurement of melt strength is conducted by pulling strands of the molten polymers or blends at constant acceleration until breakage occurs. The experimental set up consists of a capillary rheometer and a Rheotens apparatus as take-up device. The force required to uniaxially extend the strands is recorded as a function of the take-up velocity. The maximum force attained before either draw resonance or breakage occurs is defined as the melt strength. Draw resonance, which terminated in breakage, is indicated by the onset of a periodic oscillation of increasing amplitude in the measured force profile. In the absence of any observable draw resonance, the melt strength is defined as the force at break. These tests are run under the following conditions:
Mass flow rate: 1.35 gram/min
Temperature: 190° C.
Capillary length: 41.9 mm
Capillary diameter: 2.1 mm
Piston diameter: 9.54 mm
Piston velocity: 0.423 mm/s
Shear rate: 33.0 s⁻¹
Draw-down distance (die exit to take-up Wheels): 100 mm
Cooling conditions: ambient air
Acceleration: 2.4 mm/s²

Exemplary polyethylenes suitable for the inventive microcapillary films can have a melt flow rate in the range of from 0.1 to 500 g/10 minutes (measured at 190° C. and 2.16 Kg); or in the alternative from 5 to 30 g/10 minutes; or in the alternative, from 1 to 15 g/10 minutes; or in the alternative, from 1 to 10 g/10 minutes; or in the alternative, from 2 to 7 g/10 minutes.

Exemplary polypropylenes suitable for the inventive microcapillary films can have a melt flow rate in the range of from 0.1 to 500 g/10 minutes (measured at 230° C. and 2.16 Kg), or in the alternative from 2 to 60 g/10 minutes; or in the alternative from 2 to 30 g/10 minutes; or in the alternative from 2 to 20 g/10 minutes; or in the alternative from 5 to 15 g/10 minutes.

The matrix (18) may be reinforced via, for example, glass or carbon fibers and/or any other mineral fillers such talc or calcium carbonate. Exemplary fillers include, but are not limited to, natural calcium carbonates, including chalks, calcites and marbles, synthetic carbonates, salts of magnesium and calcium, dolomites, magnesium carbonate, zinc carbonate, lime, magnesia, barium sulphate, barite, calcium sulphate, silica, magnesium silicates, talc, wollastonite, clays and aluminum silicates, kaolins, mica, oxides or hydroxides of metals or alkaline earths, magnesium hydroxide, iron oxides, zinc oxide, glass or carbon fiber or powder, wood fiber or powder or mixtures of these compounds.

Examples of thermoplastic materials include, but are not limited to, homopolymers and copolymers (including elastomers) of one or more alpha-olefins such as ethylene, propylene, 1-butene, 3-methyl-1-butene, 4-methyl-1-pentene, 3-methyl-1-pentene, 1-heptene, 1-hexene, 1-octene, 1-decene, and 1-dodecene, as typically represented by polyethylene, polypropylene, poly-1-butene, poly-3-methyl-1-butene, poly-3-methyl-1-pentene, poly-4-methyl-1-pentene, ethylene-propylene copolymer, ethylene-1-butene copolymer, and propylene-1-butene copolymer; copolymers (including elastomers) of an alpha-olefin with a conjugated or non-conjugated diene, as typically represented by ethylene-butadiene copolymer and ethylene-ethylidene norbornene copolymer; and polyolefins (including elastomers) such as copolymers of two or more alpha-olefins with a conjugated or non-conjugated diene, as typically represented by ethylene-propylene-butadiene copolymer, ethylene-propylene-dicyclopentadiene copolymer, ethylene-propylene-1,5-hexadiene copolymer, and ethylene-propylene-ethylidene norbornene copolymer; ethylene-vinyl compound copolymers such as ethylene-vinyl acetate copolymer, ethylene-vinyl alcohol copolymer, ethylene-vinyl chloride copolymer, ethylene acrylic acid or ethylene-(meth)acrylic acid copolymers, and ethylene-(meth)acrylate copolymer; styrenic copolymers (including elastomers) such as polystyrene, ABS, acrylonitrile-styrene copolymer, α-methylstyrene-styrene copolymer, styrene vinyl alcohol, styrene acrylates such as styrene methylacrylate, styrene butyl acrylate, styrene butyl methacrylate, and styrene butadienes and crosslinked styrene polymers; and styrene block copolymers (including elastomers) such as styrene-butadiene copolymer and hydrate thereof, and styrene-isoprene-styrene triblock copolymer; polyvinyl compounds such as polyvinyl chloride, polyvinylidene chloride, vinyl chloride-vinylidene chloride copolymer, polymethyl acrylate, and polymethyl methacrylate; polyamides such as nylon 6, nylon 6,6, and nylon 12; thermoplastic polyesters such as polyethylene terephthalate and polybutylene terephthalate; polyurethane; polycarbonate, polyphenylene oxide, and the like; and glassy hydrocarbon-based resins, including poly-dicyclopentadiene polymers and related polymers (copolymers, terpolymers); saturated mono-olefins such as vinyl acetate, vinyl propionate, vinyl versatate, and vinyl butyrate and the like; vinyl esters such as esters of monocarboxylic acids, including methyl acrylate, ethyl acrylate, n-butyl acrylate, isobutyl acrylate, 2-ethylhexyl acrylate, dodecyl acrylate, n-octyl acrylate, phenyl acrylate, methyl methacrylate, ethyl methacrylate, and butyl methacrylate and the like; acrylonitrile, methacrylonitrile, acrylamide, mixtures thereof; resins produced by ring opening metathesis and cross metathesis polymerization and the like. These resins may be used either alone or in combinations of two or more.

In selected embodiments, thermoplastic material may, for example, comprise one or more polyolefins selected from the group consisting of ethylene-alpha olefin copolymers, propylene-alpha olefin copolymers, and olefin block copolymers. In particular, in select embodiments, the thermoplastic material may comprise one or more non-polar polyolefins.

In specific embodiments, polyolefins such as polypropylene, polyethylene, copolymers thereof, and blends thereof, as well as ethylene-propylene-diene terpolymers, may be used. In some embodiments, exemplary olefinic polymers include homogeneous polymers; high density polyethylene (HDPE); heterogeneously branched linear low density polyethylene (LLDPE); heterogeneously branched ultra low linear density polyethylene (ULDPE); homogeneously branched, linear ethylene/alpha-olefin copolymers; homogeneously branched, substantially linear ethylene/alpha-olefin polymers; and high pressure, free radical polymerized ethylene polymers and copolymers such as low density polyethylene (LDPE) or ethylene vinyl acetate polymers (EVA).

In one embodiment, the ethylene-alpha olefin copolymer may, for example, be ethylene-butene, ethylene-hexene, or ethylene-octene copolymers or interpolymers. In other particular embodiments, the propylene-alpha olefin copolymer may, for example, be a propylene-ethylene or a propylene-ethylene-butene copolymer or interpolymer.

In certain other embodiments, the thermoplastic material may, for example, be a semi-crystalline polymer and may have a melting point of less than 110° C. In another embodiment, the melting point may be from 25 to 100° C. In another embodiment, the melting point may be between 40 and 85° C.

In one particular embodiment, the thermoplastic material is a propylene/α-olefin interpolymer composition comprising a propylene/alpha-olefin copolymer, and optionally one or more polymers, e.g. a random copolymer polypropylene (RCP). In one particular embodiment, the propylene/alpha-olefin copolymer is characterized as having substantially isotactic propylene sequences. “Substantially isotactic propylene sequences” means that the sequences have an isotactic triad (mm) measured by ¹³C NMR of greater than about 0.85; in the alternative, greater than about 0.90; in another alternative, greater than about 0.92; and in another alternative, greater than about 0.93. Isotactic triads are well-known in the art and are described in, for example, U.S. Pat. No. 5,504,172 and International Publication No. WO 00/01745, which refer to the isotactic sequence in terms of a triad unit in the copolymer molecular chain determined by ¹³C NMR spectra.

In one particular embodiment, the propylene/alpha-olefin copolymer may have a melt flow rate in the range of from 0.1 to 500 g/10 minutes, measured in accordance with ASTM D-1238 (at 230° C./2.16 Kg). All individual values and subranges from 0.1 to 500 g/10 minutes are included herein and disclosed herein; for example, the melt flow rate can be from a lower limit of 0.1 g/10 minutes, 0.2 g/10 minutes, or 0.5 g/10 minutes to an upper limit of 500 g/10 minutes, 200 g/10 minutes, 100 g/10 minutes, or 25 g/10 minutes. For example, the propylene/alpha-olefin copolymer may have a melt flow rate in the range of from 0.1 to 200 g/10 minutes; or in the alternative, the propylene/alpha-olefin copolymer may have a melt flow rate in the range of from 0.2 to 100 g/10 minutes; or in the alternative, the propylene/alpha-olefin copolymer may have a melt flow rate in the range of from 0.2 to 50 g/10 minutes; or in the alternative, the propylene/alpha-olefin copolymer may have a melt flow rate in the range of from 0.5 to 50 g/10 minutes; or in the alternative, the propylene/alpha-olefin copolymer may have a melt flow rate in the range of from 1 to 50 g/10 minutes; or in the alternative, the propylene/alpha-olefin copolymer may have a melt flow rate in the range of from 1 to 40 g/10 minutes; or in the alternative, the propylene/alpha-olefin copolymer may have a melt flow rate in the range of from 1 to 30 g/10 minutes.

In one particular embodiment, the propylene/alpha-olefin copolymer has a crystallinity in the range of from at least 1 percent by weight (a heat of fusion of at least 2 Joules/gram) to 30 percent by weight (a heat of fusion of less than 50 Joules/gram). All individual values and subranges from 1 percent by weight (a heat of fusion of at least 2 Joules/gram) to 30 percent by weight (a heat of fusion of less than 50 Joules/gram) are included herein and disclosed herein; for example, the crystallinity can be from a lower limit of 1 percent by weight (a heat of fusion of at least 2 Joules/gram), 2.5 percent (a heat of fusion of at least 4 Joules/gram), or 3 percent (a heat of fusion of at least 5 Joules/gram) to an upper limit of 30 percent by weight (a heat of fusion of less than 50 Joules/gram), 24 percent by weight (a heat of fusion of less than 40 Joules/gram), 15 percent by weight (a heat of fusion of less than 24.8 Joules/gram) or 7 percent by weight (a heat of fusion of less than 11 Joules/gram). For example, the propylene/alpha-olefin copolymer may have a crystallinity in the range of from at least 1 percent by weight (a heat of fusion of at least 2 Joules/gram) to 24 percent by weight (a heat of fusion of less than 40 Joules/gram); or in the alternative, the propylene/alpha-olefin copolymer may have a crystallinity in the range of from at least 1 percent by weight (a heat of fusion of at least 2 Joules/gram) to 15 percent by weight (a heat of fusion of less than 24.8 Joules/gram); or in the alternative, the propylene/alpha-olefin copolymer may have a crystallinity in the range of from at least 1 percent by weight (a heat of fusion of at least 2 Joules/gram) to 7 percent by weight (a heat of fusion of less than 11 Joules/gram); or in the alternative, the propylene/alpha-olefin copolymer may have a crystallinity in the range of from at least 1 percent by weight (a heat of fusion of at least 2 Joules/gram) to 5 percent by weight (a heat of fusion of less than 8.3 Joules/gram). The crystallinity is measured via DSC method. The propylene/alpha-olefin copolymer comprises units derived from propylene and polymeric units derived from one or more alpha-olefin comonomers. Exemplary comonomers utilized to manufacture the propylene/alpha-olefin copolymer are C₂, and C₄ to C₁₀ alpha-olefins; for example, C₂, C₄, C₆ and C₈ alpha-olefins.

In one particular embodiment, the propylene/alpha-olefin copolymer comprises from 1 to 40 percent by weight of one or more alpha-olefin comonomers. All individual values and subranges from 1 to 40 weight percent are included herein and disclosed herein; for example, the comonomer content can be from a lower limit of 1 weight percent, 3 weight percent, 4 weight percent, 5 weight percent, 7 weight percent, or 9 weight percent to an upper limit of 40 weight percent, 35 weight percent, 30 weight percent, 27 weight percent, 20 weight percent, 15 weight percent, 12 weight percent, or 9 weight percent. For example, the propylene/alpha-olefin copolymer comprises from 1 to 35 percent by weight of one or more alpha-olefin comonomers; or in the alternative, the propylene/alpha-olefin copolymer comprises from 1 to 30 percent by weight of one or more alpha-olefin comonomers; or in the alternative, the propylene/alpha-olefin copolymer comprises from 3 to 27 percent by weight of one or more alpha-olefin comonomers; or in the alternative, the propylene/alpha-olefin copolymer comprises from 3 to 20 percent by weight of one or more alpha-olefin comonomers; or in the alternative, the propylene/alpha-olefin copolymer comprises from 3 to 15 percent by weight of one or more alpha-olefin comonomers.

In one particular embodiment,the propylene/alpha-olefin copolymer has a molecular weight distribution (MWD), defined as weight average molecular weight divided by number average molecular weight (M_{w}/Mₙ) of 3.5 or less; in the alternative 3.0 or less; or in another alternative from 1.8 to 3.0.

Such propylene/alpha-olefin copolymers are further described in details in the U.S. Pat. Nos. 6,960,635 and 6,525,157, incorporated herein by reference. Such propylene/alpha-olefin copolymers are commercially available from The Dow Chemical Company, under the tradename VERSIFY™, or from ExxonMobil Chemical Company, under the tradename VISTAMAXX™.

In one embodiment, the propylene/alpha-olefin copolymers are further characterized as comprising (A) between 60 and less than 100, preferably between 80 and 99 and more preferably between 85 and 99, weight percent units derived from propylene, and (B) between greater than zero and 40, preferably between 1 and 20, more preferably between 4 and 16 and even more preferably between 4 and 15, weight percent units derived from at least one of ethylene and/or a C₄₋₁₀ α-olefin; and containing an average of at least 0.001, preferably an average of at least 0.005 and more preferably an average of at least 0.01, long chain branches/1000 total carbons. The maximum number of long chain branches in the propylene/alpha-olefin copolymer is not critical, but typically it does not exceed 3 long chain branches/1000 total carbons. The term long chain branch, as used herein with regard to propylene/alpha-olefin copolymers, refers to a chain length of at least one (1) carbon more than a short chain branch, and short chain branch, as used herein with regard to propylene/alpha-olefin copolymers, refers to a chain length of two (2) carbons less than the number of carbons in the comonomer. For example, a propylene/1-octene interpolymer has backbones with long chain branches of at least seven (7) carbons in length, but these backbones also have short chain branches of only six (6) carbons in length. Such propylene/alpha-olefin copolymers are further described in details in the U.S. Provisional Patent Application No. 60/988,999 and International Patent Application No. PCT/US08/082599, each of which is incorporated herein by reference.

In certain other embodiments, the thermoplastic material, e.g. propylene/alpha-olefin copolymer, may, for example, be a semi-crystalline polymer and may have a melting point of less than 110° C. In preferred embodiments, the melting point may be from 25 to 100° C. In more preferred embodiments, the melting point may be between 40 and 85° C.

In other selected embodiments, olefin block copolymers, e.g., ethylene multi-block copolymer, such as those described in the International Publication No. WO2005/090427 and U.S. Patent Application Publication No. US 2006/0199930, incorporated herein by reference to the extent describing such olefin block copolymers and the test methods for measuring those properties listed below for such polymers, may be used as the thermoplastic material. Such olefin block copolymer may be an ethylene/α-olefin interpolymer:

(a) having a M_{w}/Mₙ from about 1.7 to about 3.5, at least one melting point, Tₘ, in degrees Celsius, and a density, d, in grams/cubic centimeter, wherein the numerical values of Tₘ and d corresponding to the relationship:

Tₘ>−2002.9+4538.5(d)−2422.2(d)²; or

(b) having a M_{w}/Mₙ from about 1.7 to about 3.5, and being characterized by a heat of fusion, ΔH in J/g, and a delta quantity, ΔT, in degrees Celsius defined as the temperature difference between the tallest DSC peak and the tallest CRYSTAF peak, wherein the numerical values of ΔT and ΔH having the following relationships:

ΔT>−0.1299(ΔH)+62.81 for ΔH greater than zero and up to 130 J/g,

ΔT≧48° C. for ΔH greater than 130 J/g,

wherein the CRYSTAF peak being determined using at least 5 percent of the cumulative polymer, and if less than 5 percent of the polymer having an identifiable CRYSTAF peak, then the CRYSTAF temperature being 30° C.; or

(c) being characterized by an elastic recovery, Re, in percent at 300 percent strain and 1 cycle measured with a compression-molded film of the ethylene/α-olefin interpolymer, and having a density, d, in grams/cubic centimeter, wherein the numerical values of Re and d satisfying the following relationship when ethylene/α-olefin interpolymer being substantially free of a cross-linked phase:

Re>1481−1629(d); or

(d) having a molecular fraction which elutes between 40° C. and 130° C. when fractionated using TREF, characterized in that the fraction having a molar comonomer content of at least 5 percent higher than that of a comparable random ethylene interpolymer fraction eluting between the same temperatures, wherein said comparable random ethylene interpolymer having the same comonomer(s) and having a melt index, density, and molar comonomer content (based on the whole polymer) within 10 percent of that of the ethylene/a-olefin interpolymer; or

(e) having a storage modulus at 25° C., G′ (25° C.), and a storage modulus at 100° C., G′ (100° C.), wherein the ratio of G′ (25° C.) to G′ (100° C.) being in the range of about 1:1 to about 9:1.

Such olefin block copolymer, e.g. ethylene/α-olefin interpolymer may also:

(a) have a molecular fraction which elutes between 40° C. and 130° C. when fractionated using TREF, characterized in that the fraction having a block index of at least 0.5 and up to about 1 and a molecular weight distribution, M_{w}/Mₙ, greater than about 1.3; or

(b) have an average block index greater than zero and up to about 1.0 and a molecular weight distribution, M_{w}/Mₙ, greater than about 1.3.

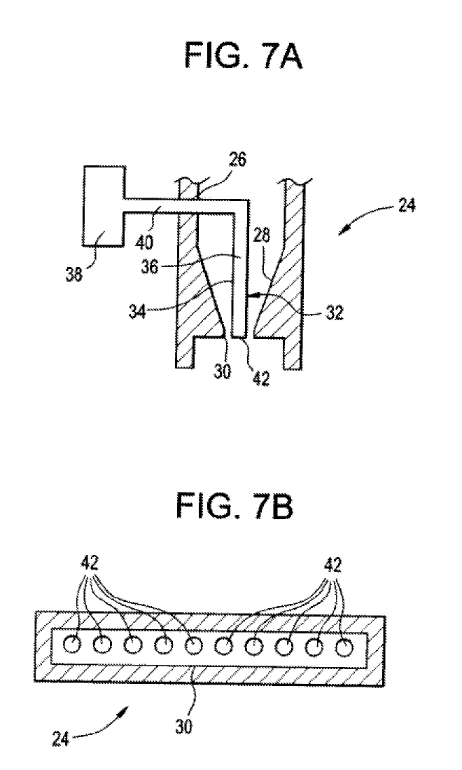

In production, the extrusion apparatus comprises screw extruder driven by a motor. Thermoplastic material is melted and conveyed to a die (24), as shown in FIGS. 7a and 7b. The molten thermoplastic material passes through die (24), as shown in FIGS. 7a and 7b, and is formed into the desired shape and cross section. Referring to FIGS. 7a and 7b, die (24) includes an entry portion (26), a convergent portion (28), and an orifice (30), which has a predetermined shape. The molten thermoplastic polymer enters entry portion (26) of the die (24), and is gradually shaped by the convergent portion (28) until the melt exits the orifice (30). The die (24) further includes injectors (32). Each injector (32) has a body portion (34) having a conduit (36) therein which is fluidly connected to a gas source (38) by means of second conduit (40) passing through the walls of die (24) around which the molten thermoplastic material must flow to pass the orifice (30). The injector (30) further includes an outlet (42). The injector (32) is arranged such that the outlet (42) is located within the orifice (30). As the molten thermoplastic polymer exits the die orifice (30), one or more gases, e.g. air or an inert gas (12) is injected into the molten thermoplastic material thereby forming microcapillaries filled with one or more gases, e.g. air or an inert gas (12). In one embodiment, one or more gases, e.g. air or an inert gas (12) is continuously injected into the molten thermoplastic material thereby forming microcapillaries filled with one or more gases, e.g. air or an inert gas (12). In another embodiment, one or more gases, e.g. air or an inert gas (12) is intermittently injected and sealed into the molten thermoplastic material thereby forming microcapillaries filled with one or more gases, e.g. air or an inert gas (12) segments and void segments.

The inventive microcapillary films according to the present invention may be used in packaging applications including, but not limited to, home and food storage bags, and/or consumer packaging, and/or industrial packaging (e.g. packaging fresh, frozen, and/or processed food products, food wrap films, packaging bags, or form, fill and seal packaging films, shrink film, stretch film, bag film, or container liners), laminating film (e.g. laminating of aluminum or or paper used for packaging for example milk or coffee), barrier films used for packaging food, e.g. fresh fruits and vegetables, fish, meat and cheese, and films for medical products. Alternatively, the inventive microcapillary films can be used in agricultural films (e.g. green house film, crop forcing film, silage film, and silage stretch film).

One or more inventive microcapillary films can form one or more layers in a multilayer structure, for example, a laminated multilayer structure or a coextruded multilayer structure. The microcapillary films may comprise one or more parallel rows of microcapillaries (channels as shown in FIG. 3b). Channels (20) (microcapillaries) may be disposed anywhere in matrix (10), as shown in FIGS. 3a-e.

The present invention may be embodied in other forms without departing from the spirit and the essential attributes thereof, and, accordingly, reference should be made to the appended claims, rather than to the foregoing specification, as indicating the scope of the invention.

### EXAMPLES

Inventive Microcapillary Films 1-10 (IMCF 1-10) were prepared according to the following process, based on the conditions reported in Table 1A and 1C. Properties of IMCF 1-10 were measured and reported in Table 2.

Comparative Films 1-4 (CF 1-4) were prepared according to the following process, based on the conditions reported in Table 1B and 1C. Properties of Comparative Films 1-5 were measured and reported in Table 2.

CF 1-4 and IMCF 1-10 were comprised of a blend of a low density poly(ethylene) polymer, with density of approximately 0.9 g/cm³ and a melt index of approximately 6 g/10 min (measured at 190° C./2.16 kg), and a linear low density ethylene octene copolymer, with density of approximately 0.9 g/cm³ and a melt index (I₂) of approximately 2 g/10 min (measured at 190° C./2.16 kg).

Comparative Films 1-4 were prepared on a film cast line, which was consisted of a 1.25-inch Killion single-screw extruder and an 8-inch wide cast die without microcapillaries. The temperature profile used for making comparative films is shown in Table 1B. The process conditions are reported in Table 1C.

Inventive MCF Films 1-10 were fabricated on a film cast line, which was consisted of a 2.5-inch Killion single-screw extruder, a transfer line to transport the polymer melt, a 24-inch wide microcapillary die with 532 microcapillary pins (having outside diameter of 0.030 inches, inner diameter of 0.014, and pin center to center spacing of 0.045 inches) inches to shape the film, a die gap of 0.059 inches and a rollstack with chill rolls to solidify the extruded films and a winder to wind the films. The temperature profile of this film cast line is given in Table 1A. The process conditions are reported in Table 1C.

TABLE 1A

| Extruder | Extruder | Extruder | Extruder | Adaptor | Transfer | Screen | Feed | Die |
|---|---|---|---|---|---|---|---|---|
| Zone 1 | Zone 2 | Zone 3 | Zone 4 | Zone | Line | Changer | block | Zone |
| (° F.) | (° F.) | (° F.) | (° F.) | (° F.) | (° F.) | (° F.) | (° F.) | (° F.) |
| 325 | 350 | 380 | 380 | 380 | 380 | 380 | 390 | 390 |

TABLE 1B

| Extruder | Extruder | Extruder | | |
|---|---|---|---|---|
| Zone 1 | Zone 2 | Zone 3 | Die 1 | Die 2 |
| (° F.) | (° F.) | (° F.) | (° F.) | (° F.) |
| 345 | 392 | 392 | 392 | 392 |

TABLE 1C

| | | | | Air | | | Air Knife | |
|---|---|---|---|---|---|---|---|---|
| | | Chill Roll | Screw | Flow | Line | Extrusion | (Inch of | Film |
| | Film- | Temperature | Speed | Rate | Speed | Pressure | Water | Width |
| | Type | (° F.) | (rpm) | (ml/min) | (ft/min) | (psi) | Level) | (inch) |
| CF 1 | non- | 143 | 20 | — | 39.1 | 2220 | — | 7 |
| | MCF | | | | | | | |
| CF 2 | non- | 143 | 20 | — | 33.9 | 2220 | — | 7 |
| | MCF | | | | | | | |
| CF 3 | non- | 143 | 20 | — | 24.7 | 2220 | — | 7 |
| | MCF | | | | | | | |
| CF 4 | non- | 143 | 20 | — | 13.1 | 2220 | — | 7 |
| | MCF | | | | | | | |
| IMCF 1 | MCF | 55 | 30 | 100 | 10 | 2280 | 11 | 22 |
| IMCF 2 | MCF | 55 | 30 | 100 | 30 | 2250 | 11 | 21 |
| IMCF 3 | MCF | 55 | 30 | 100 | 40 | 2270 | 11 | 21 |
| IMCF 4 | MCF | 55 | 30 | 100 | 50 | 2270 | 11 | 20 |
| IMCF 5 | MCF | 55 | 20 | 300 | 50 | 1740 | 11 | 20 |
| IMCF 6 | MCF | 55 | 20 | 100 | 16 | 1760 | 11 | 21 |
| IMCF 7 | MCF | 55 | 20 | 300 | 40 | 1720 | 11 | 20 |
| IMCF 8 | MCF | 55 | 20 | 100 | 40 | 1680 | 11 | 21 |
| Inventive | MCF | 55 | 13 | 200 | 48.5 | 1270 | 11 | 17 |
| MCF 9 | | | | | | | | |
| Inventive | MCF | 55 | 13 | 25 | 37 | 1240 | 11 | 20 |
| MCF 10 | | | | | | | | |

TABLE 2

| | | | | Bending | | | | | |
|---|---|---|---|---|---|---|---|---|---|
| | | | | Stiffness | | | | | |
| | | | | (Gurley) | | | | Ultimate | |
| | | Thickness | | (ASTM | Elmendorf | % Strain | % Strain | Toughness | Impact |
| | % Void | (mil) | | D6125-97, | Tear (g) | at Yield | at Break | (J/cm³) | Strength(g) |
| | Volume | (ASTM | | TAPPI T543 | (ASTM | (ASTM | (ASTM | (ASTM | (ASTM |
| | (Microscopy) | D374M) | Direction | om-11) | D1922) | D882) | D882) | D882) | D3420) |
| Comparative | 0.0% | 2.35 | MD | 3.54 ± 0.65 | 209 ± 41 | 11.2 ± 0.45 | 116.6 ± 3.97 | 17.84 ± 1.77 | — |
| 1 | | | | | | | | | |
| | | | TD | 3.67 ± 0.79 | 664 ± 78 | 10.20 ± 0.84 | 440.4 ± 56.97 | 36.14 ± 7.30 | — |
| | | | n/a | — | — | — | — | — | 1907 ± 545 |
| Comparative | 0.0% | 2.43 | MD | 7.49 ± 1.84 | 268 ± 41 | 12.6 ± 1.52 | 159.2 ± 20.62 | 23.68 ± 2.73 | — |
| Film 2 | | | | | | | | | |
| | | | TD | 3.67 ± 0.82 | 694 ± 24 | 14.00 ± 1.22 | 267.4 ± 25.00 | 22.00 ± 2.81 | — |
| | | | n/a | — | — | — | — | — | 1801 ± 462 |
| Comparative | 0.0% | 3.55 | MD | 11.13 ± 0.75 | 443 ± 39 | 15.8 ± 1.48 | 262.6 ± 15.60 | 37.91 ± 4.61 | — |
| Film 3 | | | | | | | | | |
| | | | TD | 7.94 ± 0.92 | 1057 ± 22 | 18.60 ± 1.67 | 301.8 ± 51.20 | 26.25 ± 5.63 | — |
| | | | n/a | — | — | — | — | — | 1677 ± 381 |
| Comparative | 0.0% | 9.78 | MD | 192.22 ± 35.25 | 1152 ± 85 | 27.6 ± 1.82 | 585.4 ± 35.57 | 71.62 ± 5.49 | — |
| Film 4 | | | | | | | | | |
| | | | TD | 194.82 ± 10.80 | 2688 ± 151 | 23.60 ± 0.89 | 630.2 ± 27.78 | 69.30 ± 5.03 | — |
| | | | n/a | — | — | — | — | — | 4262 ± 477 |
| Inventive | 20.3% | 10.02 | MD | 230.37 ± 55.75 | 541 ± 127 | 24.40 ± 0.89 | 510.2 ± 38.97 | 49.96 ± 5.38 | — |
| MCF 1 | | | | | | | | | |
| | | | TD | 208.52 ± 7.82 | 2867 ± 266 | 22.00 ± 0.71 | 534.4 ± 32.52 | 45.92 ± 3.93 | — |
| | | | n/a | — | — | — | — | — | 3763 ± 438 |
| Inventive | 22.2% | 3.56 | MD | 9.78 ± 1.11 | 114 ± 10 | 14.60 ± 2.07 | 175.0 ± 16.40 | 21.05 ± 2.74 | — |
| MCF 2 | | | | | | | | | |
| | | | TD | 10.44 ± 0.30 | 979 ± 53 | 17.00 ± 1.41 | 297.2 ± 62.33 | 20.75 ± 4.54 | — |
| | | | n/a | — | — | — | — | — | 1651 ± 385 |
| Inventive | 27.3% | 2.76 | MD | — | 70 ± 17 | 12.20 ± 0.84 | 159.8 ± 22.67 | 20.47 ± 2.65 | — |
| MCF 3 | | | | | | | | | |
| | | | TD | 5.26 ± 0.44 | 781 ± 34 | 13.80 ± 2.49 | 294.6 ± 52.8 | 19.13 ± 3.76 | — |
| | | | n/a | — | — | — | — | — | 1747 ± 268 |
| Inventive | 30.0% | 2.34 | MD | 6.77 ± 1.77 | 218 ± 29 | 7.80 ± 1.48 | 90.4 ± 11.7 | 11.08 ± 1.96 | — |
| MCF 4 | | | | | | | | | |
| | | | TD | 5.20 ± 0.45 | 763 ± 42 | 11.40 ± 0.55 | 391.6 ± 50.3 | 24.73 ± 4.25 | — |
| | | | n/a | — | — | — | — | — | 1766 ± 346 |
| Inventive | 29.9% | 2.13 | MD | 1.43 ± 0.63 | 41 ± 3 | 10.60 ± 1.14 | 153.0 ± 16.7 | 22.49 ± 3.34 | — |
| MCF 5 | | | | | | | | | |
| | | | TD | 1.82 ± 0.16 | 624 ± 94 | 7.20 ± 0.84 | 545.2 ± 16.1 | 45.35 ± 1.30 | — |
| | | | n/a | — | — | — | — | — | 1238 ± 292 |
| Inventive | 18.9% | 4.65 | MD | 42.96 ± 8.84 | 165 ± 38 | 20.40 ± 1.94 | 548.4 ± 20.2 | 72.48 ± 4.39 | — |
| MCF 6 | | | | | | | | | |
| | | | TD | 26.67 ± 5.54 | 971 ± 69 | 15.60 ± 2.07 | 686.6 ± 14.6 | 77.08 ± 3.40 | — |
| | | | n/a | — | — | — | — | — | >7040 |
| Inventive | 64.1% | 3.52 | MD | 10.28 ± 0.77 | 47 ± 10 | 10.00 ± 2.35 | 140.4 ± 26.4 | 13.33 ± 3.43 | — |
| MCF 7 | | | | | | | | | |
| | | | TD | 6.55 ± 1.15 | 986 ± 80 | 8.40 ± 2.70 | 553.6 ± 27.9 | 28.45 ± 2.14 | — |
| | | | n/a | — | — | — | — | — | 1114 ± 204 |
| Inventive | 50.6% | 3.27 | MD | 9.11 ± 0.80 | 25 ± 5 | 12.80 ± 1.30 | 293.0 ± 8.0 | 29.00 ± 1.42 | — |
| MCF 8 | | | | | | | | | |
| | | | TD | 6.69 ± 0.39 | 774 ± 70 | 8.00 ± 1.22 | 607.6 ± 34.4 | 34.60 ± 4.46 | — |
| | | | n/a | — | — | — | — | — | 1315 ± 245 |
| Inventive | 50.3% | 2.34 | MD | 2.36 ± 0.77 | 29 ± 3 | 5.40 ± 0.89 | 80.0 ± 8.2 | 4.98 ± 0.57 | — |
| MCF 9 | | | | | | | | | |
| | | | TD | 0.89 ± 0.41 | 583 ± 44 | 5.20 ± 0.84 | 520.4 ± 44.8 | 12.37 ± 1.14 | — |
| | | | n/a | — | — | — | — | — | 717 ± 66 |
| Inventive | 45.9% | 2.50 | MD | 2.10 ± 0.30 | 35 ± 5 | 7.40 ± 0.55 | 108.0 ± 14.0 | 8.75 ± 1.36 | — |
| MCF 10 | | | | | | | | | |
| | | | TD | 0.51 ± 0.09 | 589 ± 44 | 5.20 ± 0.45 | 547.4 ± 28.0 | 21.09 ± 2.81 | — |
| | | | n/a | — | — | — | — | — | 976 ± 102 |

We claim:

1. A microcapillary film having a first end and a second end, wherein said film comprises:
(a) a matrix comprising a thermoplastic material,
(b) at least one or more channels disposed in parallel in said matrix from the first end to the second end of said film, wherein said one or more channels are at least 1 μm apart from each other, and wherein each said one or more channels have a diameter in the range of at least 1 μm; and
wherein said microcapillary film comprise from 10 to 90 percent by volume of voidage, based on the total volume of the microcapillary film, and wherein said one or more channels has a aspect ratio in the range of from 1:1 to 100:1, measured as the ratio of longest to shortest dimensions of a channel's cross-section perpendicular to the machine direction of the film
wherein said film has a thickness in the range of from 5 μm to 500 μm, measured according to ASTM D374M-13.

2. The microcapillary film according to claim 1, wherein said microcapillary film has a thickness in the range of from 5 μm to 500 μm, measured according to ASTM D374M-13, and wherein said microcapillary comprises a thermoplastic composition having a melt strength in the range of from 3 to 50 cN.

3. The microcapillary film according to claim 1, wherein said microcapillary film has bending stiffness in the range of from 10 to 400% relative to a film of the same composition and same thickness absent any microcapillary channels, measured according to ASTM D6125-97 and/or TAPPI T543 om-11.

4. The microcapillary film according to claim 1, wherein said microcapillary film has CD Tear Strength in the range of from 75 to 125% relative to a film of the same composition and same thickness absent any microcapillary channels, measured according to ASTM D1922.

5. The microcapillary film according to claim 1, wherein said microcapillary film has CD Tear Strength (measured according to ASTM D1922)/MD Tear Strength (measured according to ASTM D1922) ratio in the range of from 1 to 40

6. The microcapillary film of claim 1, wherein said thermoplastic material is selected from the group consisting of polyolefin; polyamide; polyvinylidene chloride; polyvinylidene fluoride; polyurethane; polycarbonate; polystyrene; polyethylene vinylalcohol (PVOH), polyvinyl chloride, polylactic acid (PLA) and polyethylene terephthalate.

7. The microcapillary film of claim 6, wherein said polyolefin is polyethylene, polypropylene, propylene/ethylene copolymer, or copolymer of ethylene or propylene with one or more alpha-olefins

8. The microcapillary film of claim 7, wherein said polyethylene is characterized by having a melt index in the range of 0.1 to 500 g/10 minutes (measured at 190° C. and 2.16 Kg).

9. The microcapillary film of claim 7, wherein said polypropylene, propylene/ethylene copolymer, or copolymer propylene with one or more alpha-olefins is characterized by having a melt flow rate in the range of 0.1 to 500 g/10 minutes (measured at 230° C. and 2.16 Kg).

10. The microcapillary film of claim 2, wherein said polyamide is nylon 6.

11. The microcapillary film of claim 1, wherein said one or more channels have a cross-sectional shape selected from the group consisting of circular, rectangular, oval, star, diamond, triangular, square, curvilinear, and combinations thereof.

12. A multilayer structure comprising the microcapillary film of claim 1.

13. An article comprising the microcapillary film of claim 1.

14. The microcapillary film according to claim 1, wherein said microcapillary film has Impact Strength in the range from 30 to 400% relative to a film of the same composition and same thickness absent any microcapillary channels, measured according to ASTM D3420.
